(19) United States
(12) Patent Application Publication
(10) Pub. No.: US 2024/0138965 A1
(43) Pub. Date: May 2, 2024

(54) BIODEGRADABLE DENTAL FLOSSING DEVICE

(71) Applicant: Bal Burrows, Delta (CA)

(72) Inventor: Bal Burrows, Delta (CA)

(21) Appl. No.: 18/052,046

(22) Filed: Nov. 2, 2022

(51) Int. Cl. A61C 15/04

(52) U.S. Cl. CPC A61C 15/046

(57) ABSTRACT

A biodegradable dental floss device, formed from a handle portion and a head portion, with a strand of dental floss secured within the head portion, and the handle portion and the head portion formed from a biodegradable material, such as cardboard.

### FIELD OF THE INVENTION

The present specification relates generally to a dental flossing device, and more particularly to a biodegradable dental flossing device.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

The flossing of one's teeth is generally considered as a component of oral hygiene, along with brushing and rinsing with mouthwash or similar products. Traditional dental floss consists of nylon filaments, which may be coated in wax, with the floss dispensed from a roll and cut to a desired usable length (˜40 cm) using a blade on the container. The cut floss is then wrapped or held between the user's fingers and guided between the teeth to remove food particles caught between the teeth and in the gum line.

Some people, particularly children, may have difficulty with flossing using dental floss alone, so dental flossing devices have been developed, the most common know as floss picks. Floss picks have a strand of dental floss secured to a handle, and may be reusable or disposable, with the disposable type being more common.

However, disposable floss picks are generally made from plastic or plastic-coated materials, leading to extensive accumulating waste estimated at thousands of tons a year. Accordingly, it would be preferable for a dental floss device to be designed from a biodegradable material, while remaining rigid enough to use for dental flossing.

Accordingly, there remains a need for improvements in the art.

### SUMMARY OF THE INVENTION

In accordance with an aspect of the invention, there is provided a biodegradable dental floss device.

According to an embodiment of the invention, there is provided a biodegradable dental floss device comprising a handle portion and a head portion. The head portion comprises a head piece of shaped biodegradable material, having a first end and a second end, with a gap defined between the first ends and the second ends; and a strand of dental floss secured between the first ends and second ends. The handle portion comprises a first handle piece of non-coated rigid biodegradable material and a second handle piece of non-coated rigid biodegradable material, each piece of rigid biodegradable material covering the head portion and extending from the first ends to define a handle for the dental floss device. The first handle piece of the handle portion is adhered to the head piece of the head portion, and the second handle piece of the handle portion is adhered to the opposite side of the head piece of the head portion, with a biodegradable adhesive applied to adhere all pieces together into the dental floss device.

According to a further embodiment of the invention, all pieces may be formed from the same biodegradable material, including cardboard. The dental floss may also be formed from a biodegradable material, such as bamboo.

The shape of the head portion may be one of: semi-circular, rectangular and trapezoidal.

The strand of dental floss may be secured between the first end of the head piece of the head portion and the second end of the head piece of the head portion with a biodegradable adhesive. The strand of dental floss may be further secured between the first end of the head piece of the head portion and the second end of the head piece of the head portion via wrapping the dental floss around the first end and around the second end to secure the dental floss under tension.

According to an alternative embodiment of the invention, there is provided a biodegradable dental floss device comprising a handle portion and a head portion. The head portion comprises a first head piece of shaped biodegradable material, and a second head piece of shaped biodegradable material, each head piece of shaped biodegradable material having a first end and a second end, with a gap defined between the first ends and the second ends; and a strand of dental floss secured between the two head pieces of shaped biodegradable material, the strand of dental floss spanning the gap between the first ends and second ends. The handle portion comprises a first handle piece of non-coated rigid biodegradable material and a second handle piece of non-coated rigid biodegradable material, each piece of rigid biodegradable material covering the head portion and extending from the first ends to define a handle for the dental floss device. The first handle piece of the handle portion is adhered to the first head piece of the head portion, the first head piece of the head portion adhered to the second head piece of the head portion, and the second head piece of the head portion adhered to the second handle piece of the handle portion, with a biodegradable adhesive applied to adhere all pieces into the dental floss device

In this alternative embodiment, the strand of dental floss may be secured between the first head piece of the head portion and the second head piece of the head portion with a biodegradable adhesive. The strand of dental floss may be further secured between the first head piece of the head portion and the second head piece of the head portion via wrapping the dental floss around each of the first ends and around each of the second ends to secure the dental floss under tension

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a perspective view of a biodegradable dental flossing device embodiment;

FIG. 2 is an exploded view of FIG. 1;

FIG. 3A is a cut-away end view of the head portion of the dental flossing device;

FIG. 3B is a cut-away end view of an alternative embodiment of the head portion of the dental flossing device;

FIGS. 4A-4C are plan views of alternate shape of the head portion;

FIG. 5 is an exploded view of an alternative embodiment of the dental flossing device; and

FIG. 6 is a cut-away view of the alternative embodiment of the head portion of FIG. 5.

Like reference numerals indicated like or corresponding elements in the drawings.

### DETAILED DESCRIPTION OF THE EMBODIMENTS

The present invention relates generally to a dental flossing device, and more particularly to a biodegradable dental flossing device.

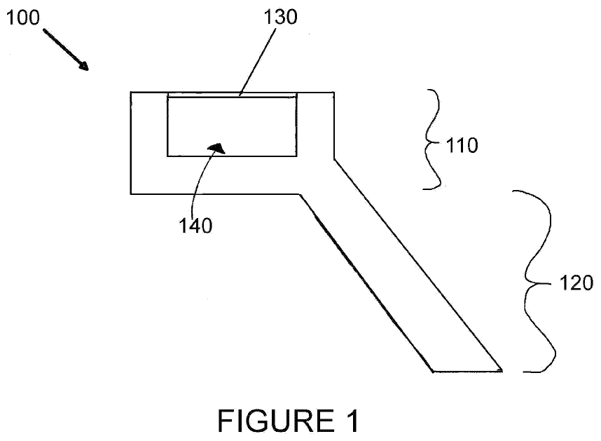

According to an embodiment as shown in FIG. 1, a biodegradable dental flossing device 100 is composed of a head portion 110 and a handle portion 120. The head portion 110 supports a strand 130 of dental floss which spans a gap 140 within the head portion. The handle portion 120 extends from the head portion 110 to provide a surface for a user to hold the dental flossing device 100.

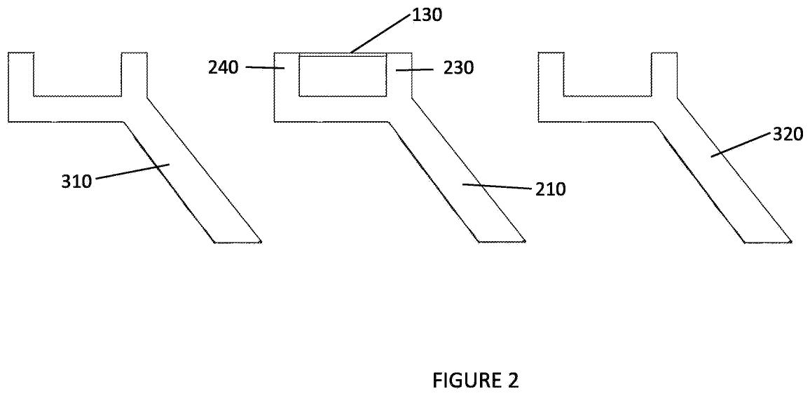

Referring to the exploded view of FIG. 2, the head portion 110 is formed from a head piece 210 of a biodegradable material, such as cardboard. The shape of head piece 210 is such that there is a first end 230 and a second end 240 which defines the gap 140 for the head portion 110.

The handle portion 120 is formed from two handle pieces 310, 320 formed from a rigid non-coated biodegradable material, such as cardboard. Each handle piece 310, 320 covers the head portion 120 by covering all of the head portion 120 by covering all of head piece 210. The remainder of each handle piece 310, 320 extends from the first end 230 of head piece 210 to form the handle portion 120.

As set out above, the handle portion 120 is adjacent to head portion 110. As shown, the handle pieces 310, 320 of handle portion 120 extend to fully cover head piece 210 of head portion 110. Accordingly, the overall shape of handle pieces 310, 320 and head piece 210 is generally the same within manufacturing tolerances. The overall shape of the head portion 110 and handle portion 120 may be varied as desired, and may further depend on the material used.

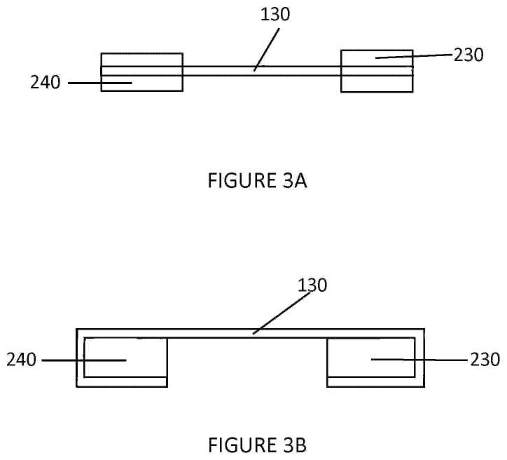

As shown in FIG. 3A, the strand of dental floss passes between the first end 230 and between the second end 240 of head piece 210. According to FIG. 3B, in an alternative, the strand 130 of dental floss may be wrapped around the first end 230 and second end 240 to secure the strand 130 of dental floss in place as well as provide sufficient tension on the strand 130 of dental floss to perm it use.

The handle pieces 310, 320 are adhered to each other with a biodegradable adhesive, such as a water-based glue, to form the handle portion 120. They are similarly adhered to opposite sides of head piece 210. When all pieces are adhered to each other, the dental floss device 100 is formed. The adhesion between the pieces results in an effect similar to lamination, such that the dental floss device 100 has sufficient rigidity to be used for flossing of the user's teeth, yet the pieces are formed from an uncoated material in order to enable biodegradation.

As the intended dental floss device 100 is a single-use device, it is understood that the combination of biodegradable materials and the biodegradable adhesive is durable enough for the intended single use, while remaining biodegradable within a reasonable time period. Further, while the strand 130 of dental floss is sufficiently small that standard nylon floss may be used, it is preferable that the strand 130 of dental floss is also formed from a biodegradable material, such as bamboo.

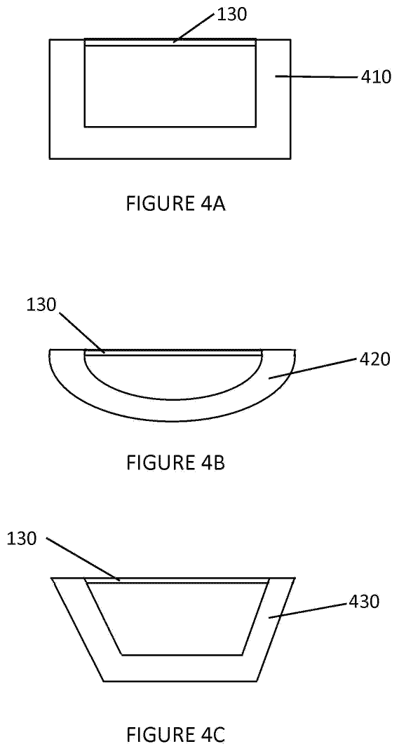

As illustrated in FIGS. 4A-4C, the head piece 210 of the head portion 110 may take different shapes for the ends and gaps. Preferred shapes may include rectangular 410 (FIG. 4A) semi circular 420 (FIG. 4B), and trapezoidal 430 (FIG. 4C), although other shapes may be used.

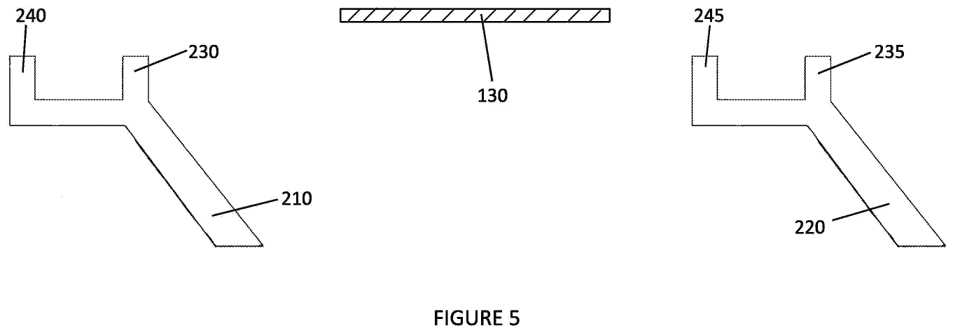

In an alternative embodiment, referring to the FIG. 5, the head portion 110 is formed from two similar head pieces 210, 220 of a biodegradable material, such as cardboard. The shape of each head piece 210, 220 is such that there is a first end 230, 235 and a second end 240, 245 on each head piece 210, 220 which defines the gap 140 for the head portion 110.

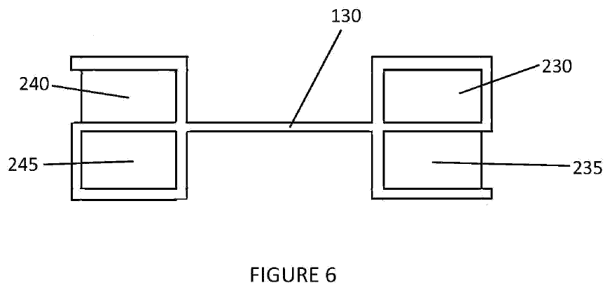

As shown in FIG. 6, the strand of dental floss passes between the first ends 230, 235 and between the second ends 240, 245. The strand 130 of dental floss may then be wrapped around the first ends 230, 235 and second ends 240, 245 to secure the strand 130 of dental floss between head pieces 210, 220 as well as provide sufficient tension on the strand 130 of dental floss to permit flossing.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the Patent and Trademark Office and the public generally, and especially the scientist, engineers and practitioners in the art who are not familiar with patent or legal terms or phraseology, to determine quickly from a cursory inspection the nature and essence of the technical disclosure of the application.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A biodegradable dental floss device, comprising:
a handle portion and a head portion,
the head portion comprising:
a head piece of shaped biodegradable material, the head piece of shaped biodegradable material having a first end and a second end,
with a gap defined between the first end and the second end; and
a strand of dental floss secured between the first end and the second end, the strand of dental floss spanning the gap between the first end and the second end, and
the handle portion comprising:
a first handle piece of non-coated rigid biodegradable material and a second handle piece of non-coated rigid biodegradable material,
each piece of rigid biodegradable material covering at least a part of the head portion and extending from the first end of the head piece to define a handle for the dental floss device,
the first handle piece of the handle portion adhered to and covering the head piece of the head portion, the second handle piece of the handle portion adhered to and covering an opposite side of the head piece of the head portion, with a biodegradable adhesive applied to adhere all pieces into the dental floss device.

2. The biodegradable dental floss device of claim 1, wherein all said pieces are of similar shape and formed from the same biodegradable material.

3. The biodegradable dental floss device of claim 2, wherein the biodegradable material is cardboard.

4. The biodegradable dental floss device of claim 1, wherein the dental floss is formed from a biodegradable material.

5. The biodegradable dental floss device of claim 1, wherein the shape of the head portion is one of: semi-circular, rectangular and trapezoidal.

6. The biodegradable dental floss device of claim 1, wherein the strand of dental floss is secured with a biodegradable adhesive.

7. The biodegradable dental floss device of claim 1, wherein the strand of dental floss is secured via wrapping the dental floss around the first end and around the second end to secure the dental floss under tension.

8. A biodegradable dental floss device, comprising:
a handle portion and a head portion,
the head portion comprising:
a first head piece of shaped biodegradable material, and a second head piece of shaped biodegradable material, each head piece of shaped biodegradable material having a first end and a second end,
with a gap defined between the first ends and the second ends; and
a strand of dental floss secured between the two head pieces of shaped biodegradable material, the strand of dental floss spanning the gap between the first ends and second ends, and
the handle portion comprising:
a first handle piece of non-coated rigid biodegradable material and a second handle piece of non-coated rigid biodegradable material,
each piece of rigid biodegradable material covering the head portion and extending from the first ends to define a handle for the dental floss device,
the first handle piece of the handle portion adhered to and covering the first head piece of the head portion, the first head piece of the head portion adhered to the second head piece of the head portion, and the second head piece of the head portion adhered to and covered by the second handle piece of the handle portion, with a biodegradable adhesive applied to adhere all pieces into the dental floss device.

9. The biodegradable dental floss device of claim 8, wherein all said pieces are formed in similar shape and from the same biodegradable material.

10. The biodegradable dental floss device of claim 9, wherein the biodegradable material is cardboard.

11. The biodegradable dental floss device of claim 8, wherein the dental floss is formed from a biodegradable material.

12. The biodegradable dental floss device of claim 8, wherein the shape of the head portion is one of: semi-circular, rectangular and trapezoidal.

13. The biodegradable dental floss device of claim 8, wherein the strand of dental floss is secured between the first head piece of the head portion and the second head piece of the head portion with a biodegradable adhesive.

14. The biodegradable dental floss device of claim 8, wherein the strand of dental floss is secured between the first head piece of the head portion and the second head piece of the head portion via wrapping the dental floss around each of the first ends and around each of the second ends to secure the dental floss under tension.
